(19) United States
(12) Patent Application Publication
(10) Pub. No.: US 2004/0083396 A1
(43) Pub. Date: Apr. 29, 2004

(54) Method and apparatus for power management in disk drives

(75) Inventor: Avraham Perahia, San Jose, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA

(21) Appl. No.: 10/687,051

(22) Filed: Oct. 16, 2003

Related U.S. Application Data
(60) Provisional application No. 60/420,635, filed on Oct. 22, 2002.

(51) Int. Cl. G06F 1/26

(52) U.S. Cl. 713/300

(57) ABSTRACT

One embodiment of the present invention is disk drive electronics that includes: (a) main electronics; (b) bus interface logic; (c) a bus interface logic monitor that monitors activity on a host interface; and (d) a regulator that supplies power to the bus interface logic monitor, the bus interface logic, and the main electronics; wherein the bus interface logic monitor determines whether to enter a sleep mode, and if so, causes power from the regulator to be removed from the bus interface logic and the main electronics.

This application claims the benefit of U.S. Provisional Application No. 60/420,635, filed on Oct. 22, 2002, which is incorporated herein by reference.

### TECHNICAL FIELD OF THE INVENTION

One or more embodiments of the present invention relate generally to method and apparatus for power management in disk drives.

### BACKGROUND OF THE INVENTION

Small form factor hard disk drives such as, for example and without limitation, disk drives that conform to “CF+ and Compact Flash Specification,” Revision 2, May 2003 issued by CompactFlash Association, Palo Alto, Calif. are typically used in battery operated portable host appliances such as, for example and without limitation, digital cameras. In such environments, the disk drive is typically operated in short bursts such as, for example and without limitation, whenever a transfer of data to/or from the disk drive from/to the host appliance is taking place. During intervals between such data transfers, the disk drive goes, by itself or at the request of the host, into a “sleep mode.” As is well known, in accordance with the prior art, in the sleep mode, all drive operations are suspended pending a demand/request from the host appliance for a new data transfer.

As is well known, most electronic components of a disk drive have power management modes which enable portions of the electronic components to be turned off in sleep mode to save energy. For example, in a typical disk drive, components fabricated utilizing integrated circuitry would be expected to have such a capability, but not components fabricated utilizing discrete components would not be expected to have such a capability. Although turning portions of the electric components off in sleep mode can reduce power consumption considerably, there is a problem in that at least some such components consume power, even in sleep mode.

For example, depending on a particular application, time spent in sleep mode can be ten (10) to one-hundred (100) times longer that time spent in an operating mode. As a result, since power for the disk drive is typically obtained from the host appliance, for example, from a host appliance battery, over long periods of time, power consumption while the disk drive is in sleep mode can have an impact on host appliance battery life.

In light of the above, there is a need to overcome one or more of the above-identified problems.

### SUMMARY OF THE INVENTION

One or more embodiments of the present invention satisfy one or more of the above-identified needs in the art. In particular, one embodiment of the present invention is disk drive electronics that comprises: (a) main electronics; (b) bus interface logic; (c) a bus interface logic monitor that monitors activity on a host interface; and (d) a regulator that supplies power to the bus interface logic monitor, the bus interface logic, and the main electronics; wherein the bus interface logic monitor determines whether to enter a sleep mode, and if so, causes power from the regulator to be removed from the bus interface logic and the main electronics.

### BRIEF DESCRIPTION OF THE DRAWINGS

FIG. 1 shows a schematic diagram of disk drive electronics that is fabricated in accordance with one or more embodiments of the present invention.

### DETAILED DESCRIPTION

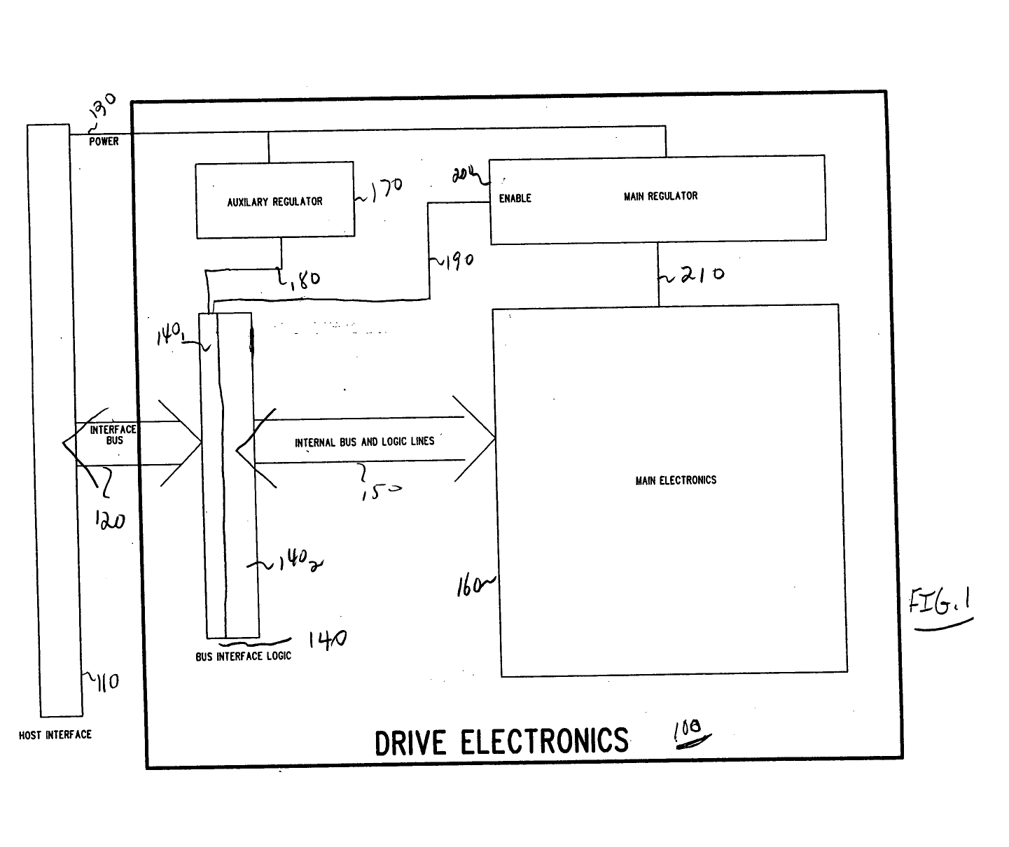

FIG. 1 shows a schematic diagram of disk drive electronics 100 that is fabricated in accordance with one or more embodiments of the present invention. As shown in FIG. 1, disk drive electronics 100 comprises host interface 110 which includes interface bus 120 and power drive 130 (for example and without limitation, power drive 130 is connected to a power source, for example and without limitation, a battery in a host appliance). The conventional functionality of host interface 110, interface bus 120, and power drive 130 may be provided in electronics that may be fabricated utilizing conventional electronics in accordance with any one of a number of methods that are well known to those of ordinary skill in the art. As further shown in FIG. 1, interface bus 120 is connected to bus interface logic 140, and bus interface logic 140 is connected in turn, over internal bus and logic lines 150 to main electronics 160. The conventional functionality of internal bus and logic lines 150 and main electronics 160 may be provided in electronics that may be fabricated utilizing conventional electronics in accordance with any one of a number of methods that are well known to those of ordinary skill in the art. In accordance with one or more embodiments of the present invention, bus interface logic 140 is comprised of two portions, bus interface logic monitor 140₁ and bus interface logic 140₂. Bus interface logic monitor 140₁ is an isolated portion of bus interface logic 140 that monitors activity on interface bus 120, and remains operative even when disk drive 100 is in sleep mode. Bus interface logic 140₂ handles remaining functionality of bus interface logic 140. The conventional functionality of bus interface logic monitor 140₁ and bus interface logic 140₂ may be provided in electronics that may be fabricated utilizing conventional electronics in accordance with any one of a number of methods that are well known to those of ordinary skill in the art.

As further shown in FIG. 1, power drive 130 is connected to, and supplies power to, auxiliary regulator 170 and main regulator 200 (as is well known, auxiliary regulator 170 and main regulator 200 maintain fixed voltages in light of potentially varying input from power drive 130). As further shown in FIG. 1, auxiliary regulator 170 supplies power to bus interface logic 140 (specifically, to bus interface logic monitor 140₁) over line 180, and main regulator 200 supplies power to main electronics 160 over line 210 in response to receipt of a “main power enable” signal that is applied as input from bus interface logic monitor 140₁. As further shown in FIG. 1, the “main power enable” signal is provided to main regulator 200 from bus interface logic monitor 140₁ over line 190 (alternatively, the “main power enable” signal may be provided to main regulator 200 from bus interface logic monitor 140₁ by transmission through bus interface logic monitor 140₂).

In accordance with one or more embodiments of the present invention, bus interface logic monitor 140₁ includes electronics that causes it to trigger entry into a sleep mode: (a) after no activity has been requested over interface bus 120 for a predetermined period of time; or (b) the host sends a command to enter a sleep mode over interface bus 120. In accordance with one or more embodiments of the present invention, bus interface logic monitor 140₁ removes “main power enable” from line 190. This causes main regulator 200 to stop supplying power to main electronics 160, and in response, main electronics 160 shuts down. Next, or simultaneously, bus interface logic monitor 140₁ causes auxiliary regulator 170 to stop supplying power to bus interface logic 140₂. For example and without limitation, this may be accomplished by opening an internal switch in bus interface logic 140 (not shown). In accordance with one or more alternative embodiments of the present invention, bus interface logic monitor 140₁ may send a signal to bus interface logic 140₂ to enter into a sleep mode. The above-described functionality may be provided in electronics that may be fabricated utilizing conventional electronics in accordance with any one of a number of methods that are well known to those of ordinary skill in the art.

Whenever disk drive 100 is in sleep mode, bus interface logic monitor 140, remains powered by separate, and preferably small and inexpensive, auxiliary regulator 170, and bus interface logic monitor 140₁ remains operative to monitor activity on interface bus 120 while main regulator 200 has been disabled. In particular, bus interface logic monitor 140₁ monitors whether disk drive 100 is addressed, and if so, in accordance with one or more embodiments of the present invention, bus interface logic monitor 140₁ includes electronics that causes it to reactivate disk drive 100 as follows. In accordance with one or more embodiments of the present invention, bus interface logic monitor 140₁ places “main power enable” onto line 190. This causes main regulator 200 to supply power to main electronics 160, and in response, main electronics 160 starts up. Next, or simultaneously, bus interface logic monitor 140₁ causes auxiliary regulator 170 to start supplying power to bus interface logic 140₂. For example and without limitation, this may be accomplished by closing an internal switch in bus interface logic 140 (not shown). In accordance with one or more alternative embodiments of the present invention, bus interface logic monitor 140₁ may send a signal to bus interface logic 140₂ to cause it be exit from sleep mode. The above-described functionality may be provided in electronics that may be fabricated utilizing conventional electronics in accordance with any one of a number of methods that are well known to those of ordinary skill in the art.

Advantageously, in accordance with one or more embodiments of the present invention described above, by isolating a bus monitoring function from the rest of drive electronics 100, power to the rest of drive electronics 100 can be totally shut off, thereby eliminating power consumption therein in sleep mode. In addition, when bus interface logic monitor 140₁ is implemented using CMOS logic, isolated bus interface logic monitor 140₁ will consume little energy while it passively monitors activity on interface bus 120.

In accordance with one or more alternative embodiments of the present invention, instead of utilizing two regulators, a single regulator is utilized. Then, in accordance with such one or more alternative embodiments, the single regulator is active in sleep mode to supply power to bus interface logic monitor 140₁, which a switch may be utilized to turn power off to the rest of disk drive electronics 100. For example, the switch could operate in response to signals from bus interface logic monitor 140₁ in much the same way the “main power enable” was utilized to turn main regulator 200 on or off as described above.

Although various embodiments that incorporate the teachings of the present invention have been shown and described in detail herein, those skilled in the art can readily devise many other varied embodiments that still incorporate these teachings.

What is claimed is:

1. Disk drive electronics that comprises:
main electronics;
bus interface logic;
a bus interface logic monitor that monitors activity on a host interface; and
a regulator that supplies power to the bus interface logic monitor, the bus interface logic, and the main electronics;
wherein the bus interface logic monitor determines whether to enter a sleep mode, and if so, causes power from the regulator to be removed from the bus interface logic and the main electronics.

2. The disk drive electronics of claim 1 wherein bus interface logic monitor further determines whether to exit a sleep mode, and if so, causes power to be applied to the bus interface logic and the main electronics.

3. The disk drive electronics of claim 1 wherein the bus interface logic monitor determines whether to enter a sleep mode by determining the absence of activity on the host interface for a predetermined length of time or in response to a predetermined message received on the host interface.

4. The disk drive electronics of claim 2 wherein the bus interface logic monitor determines whether to exit a sleep mode in response to a message received on the host interface.

5. The disk drive electronics of claim 2 wherein the regulator comprises an auxiliary regulator that supplies power to the bus interface logic monitor and the bus interface logic, and a main regulator that supplies power to the main electronics.

6. The disk drive electronics of claim 5 wherein the main regulator supplies power in response to an enable signal applied thereto from the bus interface logic monitor.

7. The disk drive electronics of claim 6 wherein the main regulator removes power from the main electronics whenever the enable signal is removed.

8. The disk drive electronics of claim 5 wherein the auxiliary regulator supplies power to the bus interface logic in response to an enable signal applied thereto from the bus interface logic monitor.

9. The disk drive electronics of claim 8 where the auxiliary regulator removes power from the bus interface logic the enable signal is removed.

10. The disk drive electronics of claim 5 wherein the auxiliary regulator supplies power to the bus interface logic in response to the bus interface logic monitor causing a switch to close.

11. The disk drive electronics of claim 10 wherein the auxiliary regulator removes power from the bus interface logic in response to the bus interface logic monitor causing a switch to open.
